(19) United States
(12) Patent Application Publication
(10) Pub. No.: US 2026/0003123 A1
(43) Pub. Date: Jan. 1, 2026

(54) STABLE OPTICAL WAVEGUIDE AND METHOD OF MANUFACTURING THE SAME

(71) Applicant: NVIDIA CORPORATION, Santa Clara, CA (US)

(72) Inventors: Liron GANTZ, Haifa (IL); Peng SUN, Palo Alto, CA (US)

(73) Assignee: NVIDIA CORPORATION, Santa Clara, CA (US)

(21) Appl. No.: 18/754,796

(22) Filed: Jun. 26, 2024

(51) Int. Cl. G02B 6/293; G02B 6/12

(52) U.S. Cl. CPC G02B 6/29338; G02B 6/12007; G02B 2006/12176

(57) ABSTRACT

Some embodiments of the present disclosure are directed to an optical device including a stable optical waveguide loop and method of manufacturing the same. For example, an optical device (e.g., an optical ring resonator) may include a substrate and an optical waveguide loop formed on the substrate. The optical waveguide loop may define a path, where the optical waveguide loop may have an inner and outer radius that may be configured to be variable along the path of the optical waveguide loop. Further, a distance between the inner radius and a corresponding outer radius may define a width of the optical waveguide loop, where the width may be variable along the path of the optical waveguide loop. Additionally, or alternatively, the width may be configured to admit a plurality of higher order modes of light that may couple to a fundamental mode of light.

### TECHNOLOGICAL FIELD

The present disclosure relates to optical devices (e.g., waveguide loops) and methods of manufacturing the same.

### BACKGROUND

With the shift towards optical systems and solutions within many fields, there is demand for precise and consistent control over the modulation and filtering of light-based signals with lower power consumption. To meet these demands, new devices, and improvements to current devices are being developed.

### GENERAL DESCRIPTION

In one aspect, the present disclosure is directed to an optical device including a substrate and an optical waveguide loop formed on the substrate, where the optical waveguide loop defines a path, the optical waveguide loop has an inner radius, and the inner radius has a length that is variable along the path of the optical waveguide loop.

In some embodiments, the optical waveguide loop may have an outer radius, and the outer radius may have a length that is variable along the path of the optical waveguide loop.

In some embodiments, a distance between the inner radius and a corresponding outer radius may define a width of the optical waveguide loop, and the width may be variable along the path of the optical waveguide loop. Additionally, or alternatively, the width may be varied to admit a plurality of higher order modes.

In some embodiments, the optical waveguide loop may have at least one coupling region, and a width of the optical waveguide loop may have a minimum width at the at least one coupling region. Additionally, or alternatively, the minimum width of the optical waveguide loop may correspond to a width of a coupling light transmitting element. In some embodiments, the optical waveguide loop may have a center point substantially equidistant from the path, where the at least one coupling region and the center point define an axis of the optical waveguide loop, a radial vector extending from the center point to the path defines an angle θ, and the length of the inner radius varies along the path as a function of the angle θ. For example, the function may be a Fourier series. As another example, the function may be a series expansion of a function.

In some embodiments, the optical waveguide loop may have an outer radius, where the outer radius has a length that varies along the path as a function of the angle θ, the optical waveguide loop is configured to act as an all-pass filter, and the inner radius and the outer radius are defined by the function:

$$r ( θ ) = {r}_{0} + {\sum }_{n = 1}^{N} ( {c}_{n} cos n θ ) - {\sum }_{n = 1}^{N} ( {c}_{n} ) .$$

In some embodiments, the optical waveguide loop may have an outer radius, where the outer radius has a length that varies along the path as a function of the angle θ, the optical waveguide loop is configured to act as an add-drop multiplexer, and the inner radius and the outer radius are defined by the function:

$$r ( θ ) = {r}_{0} + {\sum }_{n = 1}^{N} ( {c}_{n} cos 2 n θ ) - {\sum }_{n = 1}^{N} ( {c}_{n} ) .$$

In some embodiments, the optical waveguide loop may have at least one axis of symmetry.

In some embodiments, the optical waveguide loop may be configured to couple a fundamental mode to a plurality of higher order modes propagating within the optical waveguide loop. Additionally, or alternatively, coupling of the fundamental mode to the plurality of higher order modes may reduce sensitivity of the optical device to variations in etch depth of the optical waveguide loop.

In another aspect, the present disclosure is directed to a method of manufacturing an optical device. The method may include providing a substrate including at least one bus waveguide and etching, in the substrate, an optical waveguide loop, where the optical waveguide loop defines a path, the optical waveguide loop has an inner radius and an outer radius, and at least one of the inner radius or the outer radius is variable along the path of the optical waveguide loop.

In some embodiments, the substrate may include a silicon-on-insulator, polymer, plasmonic material, and/or the like.

In some embodiments, the inner radius may have an inner radius length, the outer radius may have an outer radius length, and the inner radius length and the outer radius length may be determined by a Fourier series.

In some embodiments, etching the optical waveguide loop in the substrate may include etching the optical waveguide loop in the substrate using photolithography techniques and dry-etching techniques.

In some embodiments, the method of manufacturing is CMOS-compatible.

In yet another aspect, the present disclosure is directed to an optical ring resonator. The optical ring resonator may include a substrate and an optical waveguide loop formed on the substrate, where the optical waveguide loop defines a circular path, the optical waveguide loop has an inner radius and an outer radius, a distance between the inner radius and the outer radius at a given point along the circular path defines a loop width, and the loop width is variable along the circular path.

In some embodiments, at an initial point along the circular path the inner radius may have an initial inner radius, the outer radius may have an initial outer radius, and a distance between the initial inner radius and the initial outer radius at the initial point defines an initial loop width. Additionally, or alternatively, the initial loop width may be a minimum loop width, and at another point along the circular path rotated at around 90 degrees from the initial point, the loop width may be a maximum loop width. In some embodiments, the initial loop width may be a minimum loop width, and at another point along the circular path rotated at around 180 degrees from the initial point, the loop width may be a maximum loop width.

In yet another aspect, the present disclosure is directed to an optical ring resonator having a geometry that utilizes less thermal tuning power as compared to optical ring resonators having a conventional geometry.

In yet another aspect, the present disclosure is directed to an optical ring resonator having a geometry that results in a smaller spread in resonant wavelength value as compared to optical ring resonators having a conventional geometry.

In yet another aspect, the present disclosure is directed to an optical ring resonator having a geometry that has larger silicon volume as compared to conventional optical ring resonators, which mitigates self-heating at high optical power.

The features, functions, and advantages that have been discussed may be achieved independently in various embodiments of the present disclosure or may be combined with yet other embodiments, further details of which may be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 illustrates a graph of optical ring resonance versus electrical tuning power for a plurality of conventional optical ring resonator devices having different radii;

FIG. 2 illustrates a graph of effective refractive indices of optical waveguide loops versus etch depths of the optical waveguide loops for a plurality of optical waveguide widths;

FIG. 3 illustrates an overhead view of an optical ring resonator, in accordance with an embodiment of the present disclosure;

FIG. 4 illustrates an overhead view of an optical ring resonator, in accordance with an embodiment of the present disclosure;

FIG. 5A illustrates a graph of effective refractive indices of optical waveguide loops versus widths of the optical waveguide loops for a plurality of light modes;

FIG. 5B illustrates a graph of phase delay of a fundamental mode of light versus positions along a circular path for two etch depth values of an optical waveguide loop;

FIG. 6A illustrates a graph of phases of propagating light versus wavelengths of light at two different etch depth values for an optical ring resonator in accordance with an embodiment of the present disclosure and for a conventional optical ring resonator;

FIG. 6B illustrates a graph of values for the proportion of the fundamental mode of light transmitted versus wavelengths of light at two different etch depth values for an optical ring resonator in accordance with an embodiment of the present disclosure;

FIG. 7 illustrates a graph of transmissions of light at different wavelength values for two different etch depth values for an optical ring resonator in accordance with an embodiment of the present disclosure and for a conventional optical ring resonator; and

FIG. 8 illustrates a method for manufacturing an optical device, in accordance with an embodiment of the disclosure.

### DETAILED DESCRIPTION OF EMBODIMENTS

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Furthermore, when it is said herein that something is “based on” something else, it may be based on one or more other things as well. In other words, unless expressly indicated otherwise, as used herein “based on” means “based at least in part on” or “based at least partially on.” Also, as used herein, the term “or” is intended to be inclusive when used in a series and may be used interchangeably with “and/or,” unless explicitly stated otherwise (e.g., if used in combination with “either” or “only one of”). As used herein, terms such as “top,” “about,” “around,” and/or the like are used for explanatory purposes in the examples provided below to describe the relative position of components or portions of components. As used herein, the terms “substantially” and “approximately” refer to tolerances within manufacturing and/or engineering standards. Like numbers refer to like elements throughout. No element, act, or instruction used herein should be construed as critical or essential unless explicitly described as such.

As noted, with the shift towards optical systems and solutions within many fields, there is demand for precise and consistent control over the modulation and filtering of light-based signals while maintaining high efficiency and low power consumption. To meet these demands, new devices, and improvements to current devices are being developed. Optical ring resonators are one such device that is receiving interest due to its low power dissipation, compactness, and precise signal extraction in various applications (e.g., a wavelength division multiplexing transceiver). An optical ring resonator is a device containing an optical waveguide loop coupled to at least one light input or light output, where light propagating in the optical waveguide loop constructively interferes with itself, increasing in intensity. Optical ring resonators are fabricated to have a specific resonant wavelength that is set by the refractive index of the optical ring resonator and the dimensions of the optical ring resonator and are fabricated to have relatively simple geometries (e.g., a perfect circle). Typically, the width of the optical waveguide loop of the optical ring resonator is constant and fabricated to a sufficient dimension to only support propagation of a single mode of light. However, optical ring resonators are susceptible to manufacturing variations in waveguide width, etch-depth width, and etch-depth nonuniformities that shift the resonant wavelength of the optical ring resonator, thereby compromising its use. Current solutions to account for this resonant wavelength variation entail improving the etch tools, restricting device spacing on the substrate, and thermally tuning the resonant wavelength.

The present disclosure is directed to a stable optical ring resonator that includes a substrate (e.g., silicon on insulator substrate) that includes an optical waveguide loop etched into the substrate and, in some embodiments, at least one bus waveguide etched into the substrate such that specific wavelengths of light optically couple to and from the at least one bus waveguide and the optical waveguide loop. The present disclosure seeks to remedy the issues associated with optical ring resonator manufacturing (e.g., etch-depth variation, etch-depth nonuniformities, and/or the like) via an advanced geometry of the optical waveguide loop of an optical ring resonator device. The technique of the present disclosure exploits optical properties of coupled modes to decouple resonance variation from etch variation, regardless of the actual etching variation on the wafer. The optical ring resonator may be implemented in modulators and/or wavelength demultiplexers.

The optical ring resonator can be operated as both a demultiplexer and a modulator. Electronics can encode data onto an optical channel. Such a method of operating the device results in an encoded optical channel being output on the output waveguide. The optical device may include one or more waveguides that carry light signals to and/or from optical components. Examples of optical components that can be included on the device include, but are not limited to, one or more components selected from a group consisting of facets through which light signals can enter and/or exit a waveguide, entry/exit ports through which light signals can enter and/or exit a waveguide from above or below the device, multiplexers for combining multiple light signals onto a single waveguide, demultiplexers for separating multiple light signals such that different light signals are received on different waveguides, optical couplers, optical switches, lasers that act as a source of a light signal, amplifiers for amplifying the intensity of a light signal, attenuators for attenuating the intensity of a light signal, modulators for modulating a signal onto a light signal, modulators that convert a light signal to an electrical signal, and vias that provide an optical pathway for a light signal traveling through the device from the bottom side of the device to the top side of the device. Additionally, the device can include electrical components. For instance, the device can include electrical connections for applying a potential or current to a waveguide and/or for controlling other components on the optical device.

In some embodiments, the shape of the optical waveguide loop shape may be synthesized using a function (e.g., a Fourier series) tuned to target dimensions of the optical waveguide loop. For example, the function may include a summation over trigonometric functions (e.g., normalized trigonometric series). The sum may truncate at a chosen N^{th} order based on target dimensions of the optical waveguide loop, manufacturing constraints, and/or the like. In some embodiments, inclusion of a first order of N may configure the optical waveguide loop to taper up in width to excite higher order modes of light in a region of the optical waveguide loop. Additionally, or alternatively, inclusion of a second and/or third order of N may configure the optical ring resonator to remove higher order modes of light in a region of the optical waveguide loop. In some embodiments, inclusion of higher orders of N (e.g., greater than the second or third order) may further configure the optical waveguide loop to taper up in width to excite higher order modes of light in a region of the optical waveguide loop and/or to remove higher order modes of light in a region of the optical waveguide loop. In some embodiments, an N^{th} order may be chosen based on orders higher than N minimally impacting the geometry and/or the function of the optical waveguide loop (e.g., the contribution of higher order terms to the sum is negligible compared to lower order terms). For example, the sum may truncate at a chosen N^{th} order of between about 3 and 7, such as 4, 5, or 6. As another example, the sum may truncate at a higher chosen N^{th} order of between about 8 and 15, such as 9, 10, 11, or 12.

In some embodiments, the optical waveguide loop of optical ring resonators may have inner and outer radii having lengths that depend on an angular position with respect to an axis of the optical waveguide loop, yielding optical ring resonators with a varying width across the optical waveguide loop, where the minimum width (e.g., a width value only supporting the propagation of a single fundamental mode of light) of the optical waveguide loop is in a coupling region (e.g., a region of the optical waveguide loop proximate a coupling waveguide) and is comparable to the width of a bus waveguide. In other words, optical ring resonators may have angle-dependent radii, yielding optical ring resonators with a varying width across the optical waveguide loop. Such a structure may be configured to couple a fundamental mode of light with higher order modes of light so that the phase constant of the coupled mode of light is less susceptible to variations in the etch depth of the optical waveguide loop of the optical ring resonator. In other words, the coupling of a fundamental mode of light with higher order modes of light decouples resonant wavelength variation from etch depth variation in optical waveguide loops. As will be appreciated by one of ordinary skill in the art in view of this disclosure, the intentional incorporation of higher order modes of light is orthogonal to common methods in optical systems which typically seek to suppress the amount of higher order modes of light present in the optical system to improve performance. As such, the stable optical waveguide loop and methods of manufacturing the same of the present disclosure represent a novel approach to alleviating common problems in the field of the present disclosure.

In some embodiments, a coupling region may correspond to a location where the optical waveguide loop is in close proximity to a straight waveguide (e.g., a coupling waveguide). If the cross section (e.g., a width) of the optical waveguide loop resembles that of the straight waveguide, then photons in the straight waveguide can overcome the small gap in-between the optical waveguide loop and the straight waveguide and “tunnel” to the optical waveguide loop (or vice versa). In this regard, a coupling strength decreases exponentially as the gap between the optical waveguide loop and the straight waveguide increases. In some embodiments, a width of the gap between the optical waveguide loop and the straight waveguide may be about 150 nanometers. Furthermore, by reducing the width of the optical waveguide loop in the coupling region to the minimum width, the optical waveguide loop may only support the propagation of a single fundamental mode of light.

As mentioned above, a current method in the field of optics for tuning an optical ring resonator to a desired resonant wavelength value involves thermal tuning of the optical ring resonator. As will be appreciated by one of ordinary skill in the art in view of the present disclosure, a refractive index of the material (e.g., silicon) including the optical ring resonator may increase with temperature. In other words, an increase in temperature of the optical ring resonator may redshift the ring resonance wavelength accordingly. Optical ring resonators having a geometry of the present disclosure utilize significantly less thermal tuning power as compared to optical ring resonators having a conventional geometry due to the smaller spread in resonant wavelength value. Such optical ring resonators have larger silicon volume as compared to conventional optical ring resonators, which mitigates self-heating at high optical power. As will be appreciated by one of ordinary skill in the art in view of the present disclosure, such improvements in device performance are highly advantageous in practical applications.

In some embodiments, methods of fabricating optical ring resonators of the present disclosure may include providing a substrate including at least one bus waveguide and etching an optical waveguide loop with target dimensions and a geometry given by a function into the surface of the substrate. In some embodiments, the substrate of the optical ring resonator may include a silicon-on-insulator, polymer, plasmonic material, and/or the like. Additionally, or alternatively, etching the optical waveguide loop on the substrate may include using photolithography techniques and dry-etching techniques. Further, in some embodiments, methods of manufacturing optical ring resonators of the present disclosure are highly compatible with current complementary metal-oxide-semiconductor (CMOS) manufacturing methods.

In some embodiments, the substrate may be made of silicon, as long as the waveguide core and/or the ring resonator are made of higher index materials and are sandwiched by lower index materials. For example, some embodiments may include a thin silicon slab (e.g., ˜300 nanometers thick) that is optically/electrically isolated from a thick silicon substrate (e.g., ˜500 microns thick) by a buried oxide layer (e.g., ˜2 μm thick). Using such an arrangement, waveguides and ring resonators may be manufactured in the thin silicon slab layer.

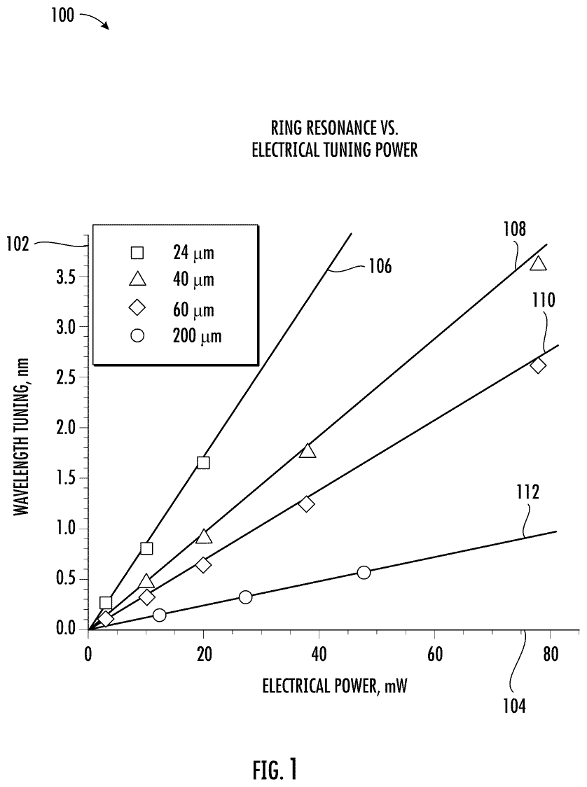

FIG. 1 illustrates a graph 100 of optical ring resonance versus electrical tuning power for a plurality of conventional optical ring resonator devices having different radii. The graph 100 includes a y-axis 102 and an x-axis 104, where the y-axis 102 lists values of wavelength tuning in nanometers and the x-axis 104 lists values of electrical power in milliwatts. The graph 100 further includes a plurality of data points per radii value defining linear fits 106, 108, 110, and 112 for a conventional optical ring resonator.

As will be appreciated by one of ordinary skill in the art in view of the present disclosure, the graph 100 demonstrates the dependency on thermal tuning of conventional optical ring resonators to reach the target resonant wavelength value. In other words, the graph 100 shows that the more a conventional optical ring resonator deviates from a target resonant wavelength value, the more electrical power is required to tune the wavelength of the conventional optical ring resonator back to the target resonant wavelength value. Further, the graph 100 shows the increase in required electrical power per nanometer of wavelength tuning as the radius increases for a conventional optical ring resonator.

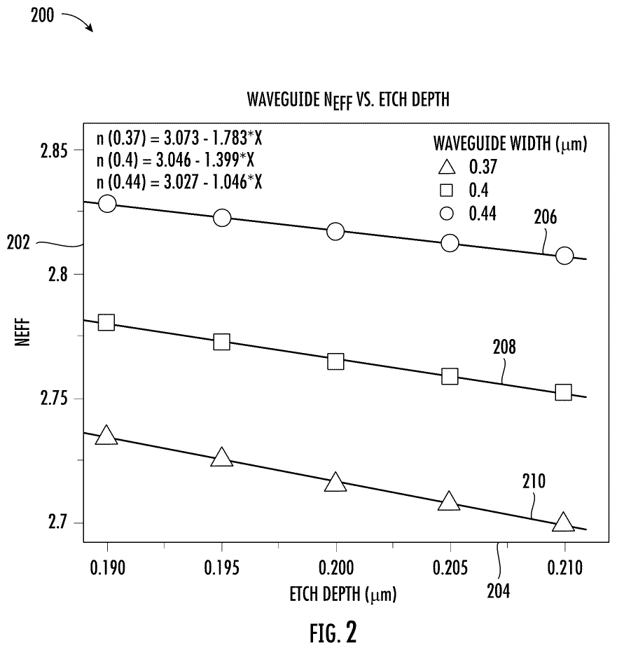

FIG. 2 illustrates a graph 200 of effective refractive indices of optical waveguide loops versus etch depths of the optical waveguide loops for a plurality of optical waveguide widths. The graph 200 includes a y-axis 202 and an x-axis 204, where the y-axis 202 lists values of effective refractive indices and the x-axis 204 lists values of etch depth in micrometers. The graph 200 further includes a plurality of data points per optical waveguide width defining linear fits 206, 208, and 210 for a conventional optical ring resonator.

As will be appreciated by one of ordinary skill in the art in view of the present disclosure, the graph 200 demonstrates that there is a change in the optical behavior of conventional optical ring resonators as the etch depth of the optical waveguide loop is varied. Further, the graph 200 demonstrates, via the slopes of the linear fits 206, 208, and 210, that as the width of the optical waveguide loop increases, the less susceptible the optical ring resonator is to variations in the etch depth of the optical waveguide loop.

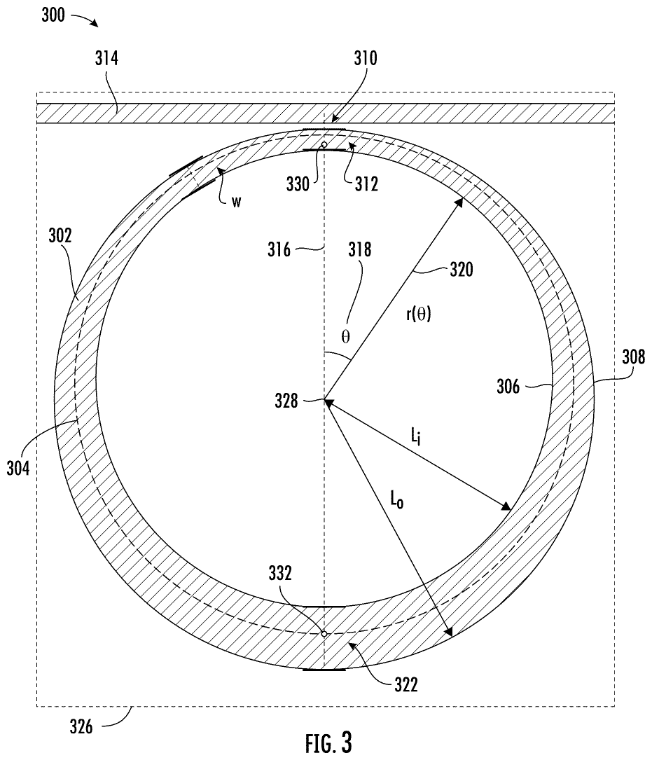

FIG. 3 illustrates an overhead view of an optical ring resonator 300, in accordance with an embodiment of the present disclosure. In some embodiments, the optical ring resonator 300 includes an optical waveguide loop 302, where the structure of the optical waveguide loop 302 defines a circular path 304. The boundaries of the optical waveguide loop 302 may be defined via an inner radius 306 and an outer radius 308, where at least one of the inner 306 and outer 308 radii vary in length Lᵢ and Lₒ, respectively, along the circular path 304. For example, and as shown in FIG. 3, the inner radius 306 and the outer radius 308 vary in length Lᵢ and Lₒ, respectively, along the circular path 304.

Stated differently, a distance between the inner radius 306 and the outer radius 308 at a given location along the circular path 304 may define a width W of the optical waveguide loop 302, as shown in FIG. 3. In some embodiments, and as also shown in FIG. 3, the width W of the optical waveguide loop 302 may be variable along the circular path 304. For example, the optical waveguide loop 302 may have a minimum loop width 312 (e.g., ˜370 nm) and a maximum loop width 322, as shown in FIG. 3. In some embodiments, a position of the maximum loop width 322 along the circular path 304 may be rotated by around 180 degrees from a position of the minimum loop width 312 along the circular path 304, as shown in FIG. 3.

In some embodiments, the optical ring resonator 300 may include at least one coupling light transmitting element, such as a coupling waveguide 314, as shown in FIG. 3. The coupling waveguide 314 may be disposed proximate to the optical waveguide loop 302. For example, and as shown in FIG. 3, the optical waveguide loop 302 may include a coupling region 310, and the coupling waveguide 314 may be disposed proximate the coupling region 310 of the optical waveguide loop 302. Further, in some embodiments, the minimum loop width 312 of the optical waveguide loop 302 proximate the coupling region 310 may correspond to a width of the coupling waveguide 314. For example, and as shown in FIG. 3, the minimum loop width 312 may correspond to and/or be fixed according to the width of the coupling waveguide 314, and the minimum loop width 312 may be a minimum width for the optical waveguide loop 302. As will be appreciated by one of ordinary skill in the art in view of the present disclosure, in some embodiments, and as shown in FIG. 3, the structure of the at least one coupling waveguide 314 of the optical ring resonator 300 may be configured for a given role in an optical system (e.g., configured to act as an all-pass filter).

In some embodiments, the optical ring resonator 300 may have an axis 316, a center point 328 (e.g., a point within the optical ring resonator 300 that is equidistant from the circular path 304), and a radial vector 320. For example, and as shown in FIG. 3, the axis 316 may pass through both the coupling region 310 and the center point 328, thereby defining the alignment of the axis 316 with respect to the optical ring resonator 300. Further, in some embodiments, the radial vector 320 may start from the center point 328 and may extend to a position on the optical waveguide loop 302. In some embodiments, and as shown in FIG. 3, the offset of the radial vector 320 from the axis 316 may define an angle 318. The angle 318 may be used to identify a location along the circular path 304 of the optical waveguide loop 302. Further, in some embodiments, for a specific value of the angle 318 there may be a corresponding inner radius 306 and outer radius 308, where the value of the inner radius 306 and outer radius may be dependent on the value of the angle 318. In other words, the angle 318 may serve as a variable in a function defining a radius value for some embodiments of the optical ring resonator 300.

For example, and as shown in FIG. 3, the inner radius 306 may decrease along the circular path 304 from an initial point 330 in an initial loop width with an initial, maximum inner radius in the coupling region 310 to a minimum inner radius at another point 332, corresponding to the position of the maximum loop width 322. In some embodiments, the change of the inner radius 306 from a maximum to a minimum value may correspond with a rotation of the angle 318 by around 180 degrees along the circular path 304, as shown in FIG. 3. In some embodiments, the inner radius 306 may increase in value along the remaining portion of the circular path 304, from the position of the maximum loop width 322 to a maximum inner radius in the coupling region 310, as shown in FIG. 3.

Further, and as shown in FIG. 3, the outer radius 308 may increase along the circular path 304 from an initial point 330 in an initial loop width with an initial, minimum outer radius in the coupling region 310 to a maximum outer radius at another point 332, corresponding to the position of the maximum loop width 322. In some embodiments, the change of the outer radius 308 from a minimum to a maximum value may correspond with a rotation of the angle 318 by around 180 degrees along the circular path 304, as shown in FIG. 3. In some embodiments, the outer radius 308 may decrease in value along the remaining portion of the circular path 304, from the position of the maximum loop width 322 to a minimum outer radius in the coupling region 310, as shown in FIG. 3.

In some embodiments, and as shown in FIG. 3, the changing in value of the inner radius 306 and the outer radius 308 may correspond with a changing in value of the width W along the circular path 304 of the optical waveguide loop 302. In other words, the changes in radius values may cause a tapering up or tapering down in the width W of the optical waveguide loop 302. In some embodiments, the inner radius 306 and the outer radius 308 may not steadily increase or decrease in value from a minimum to maximum value or a maximum to minimum value. Stated differently, the inner radius 306 and the outer radius 308 may briefly decrease in value during a period of increase or may briefly increase in value during a period of decrease. In some embodiments, the optical waveguide loop 302 may have at least one axis of symmetry. For example, the optical waveguide loop 302 may have mirror symmetry across the axis 316, as shown in FIG. 3.

In some embodiments, the inner radius 306 and outer radius 308 may be determined via functions (e.g., one or more Fourier series and/or the like). Additionally, or alternatively, the functions may be dependent on the angle 318. For example, the function determining the inner radius 306 and the outer radius 308 may have the form

$$r ( θ ) = {r}_{0} + {\sum }_{n = 1}^{N} ( {c}_{n} cos n θ ) - {\sum }_{n = 1}^{N} ( {c}_{n} ) ,$$

where r(θ) may be the value for the inner radius 306 or the outer radius 308, r₀ may be an initial value for the inner radius 306 or the outer radius 308 (e.g., in the coupling region 310), and cₙ's may be coefficients associated with a Fourier series. As will be appreciated by one of ordinary skill in the art in view of the present disclosure, the values of the coefficients cₙ may be set to optimize or minimize certain aspects of a system. In some embodiments, the functions may include different terms, may truncate at different orders of N, may have different and/or additional variable dependencies, and/or the like.

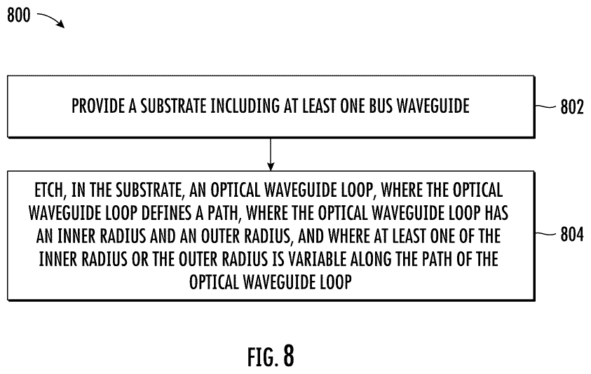

In some embodiments, the optical ring resonator 300 may include a substrate 326, and the coupling waveguide 314 and the optical waveguide loop 302 may be etched on the substrate 326. For example, the optical ring resonator 300 may be manufactured in a manner similar to the method 800 as shown and described herein with respect to FIG. 8.

As will be appreciated by one of ordinary skill in the art in view of the present disclosure, the optical ring resonator 300 may include other elements, such as additional coupling waveguides, additional optical waveguide loops, heating elements, and/or the like. For example, the optical ring resonator 300 may include a metal heater, a silicon heater, a PN junction, and/or the like for tuning the optical ring resonator. In some embodiments, a metal heater and/or a silicon heater may tune the resonance wavelength in a relatively slow manner, while a PN junction may tune the resonance wavelength in a relatively fast manner. As another example, embodiments may correspond to a couple-resonator optical waveguide (CROW), which may include multiple stacked optical waveguide loops. Additionally, or alternatively, embodiments of the optical ring resonator 300 may not include coatings (e.g., due to incompatibility with CMOS technology).

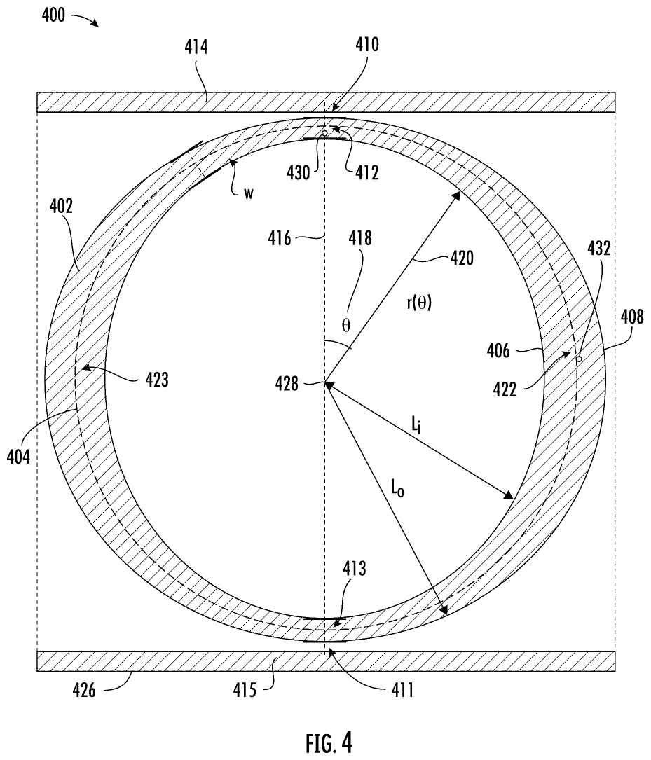

FIG. 4 illustrates an overhead view of an optical ring resonator 400, in accordance with an embodiment of the present disclosure. In some embodiments, the optical ring resonator 400 includes an optical waveguide loop 402, where the structure of the optical waveguide loop 402 defines a circular path 404. The boundaries of the optical waveguide loop 402 may be defined via an inner radius 406 and an outer radius 408, where at least one of the inner 406 and outer 408 radii vary in length Lᵢ and Lₒ, respectively, along the circular path 404. For example, and as shown in FIG. 4, the inner radius 406 and the outer radius 408 vary in length Lᵢ and Lₒ, respectively, along the circular path 404.

Stated differently, a distance between the inner radius 406 and the outer radius 408 at a given location along the circular path 404 may define a width W of the optical waveguide loop 402, as shown in FIG. 4. In some embodiments, and as also shown in FIG. 4, the width W of the optical waveguide loop 402 may be variable along the circular path 404. For example, the optical waveguide loop 402 may have a first minimum loop width 412 (e.g., ˜370 nm), a second minimum loop width 413 (e.g., ˜370 nm), a first maximum loop width 422, and a second maximum loop width 423, as shown in FIG. 4. In some embodiments, a position of the first maximum loop width 422 along the circular path 404 may be rotated by around 90 degrees from a position of the first minimum loop width 412 along the circular path 404, as shown in FIG. 4. In some embodiments, and as shown in FIG. 4, a position of the second minimum loop width 413 along the circular path 404 may be rotated around 90 degrees from a position of the first maximum loop width 422. In some embodiments, and as shown in FIG. 4, a position of the second maximum loop width 423 along the circular path 404 may be rotated around 90 degrees from a position of the second minimum loop width 413.

In some embodiments, the optical ring resonator 400 may include a first coupling waveguide 414 (e.g., a linear input waveguide) and a second coupling waveguide 415 (e.g., a linear output waveguide), as shown in FIG. 4. The first coupling waveguide 414 and the second coupling waveguide 415 may be disposed proximate to the optical waveguide loop 402.

In some embodiments, and as shown in FIG. 4, the first coupling waveguide 414 and the second coupling waveguide 415 may be disposed proximate opposite sides of the optical waveguide loop 402. For example, and as shown in FIG. 4, the optical waveguide loop 402 may include a first coupling region 410 and a second coupling region 411. The first coupling waveguide 414 may be disposed proximate the first coupling region 410 of the optical waveguide loop 402, and the second coupling waveguide 415 may be disposed proximate the second coupling region 411 of the optical waveguide loop 402. As will be appreciated by one of ordinary skill in the art in view of the present disclosure, in some embodiments, and as shown in FIG. 4, the structure of the first coupling waveguide 414 and the second coupling waveguide 415 of the optical ring resonator 400 may be configured for a given role in an optical system (e.g., configured to act as an add-drop multiplexer).

As will be appreciated by one of ordinary skill in the art in view of the present disclosure, an add-drop multiplexer may combine and/or multiplex several lower-bandwidth streams of data into a single beam of light. Furthermore, an add-drop multiplexer may add one or more lower-bandwidth signals to an existing high-bandwidth data stream, and at the same time may extract or drop other low-bandwidth signals, removing them from the stream and redirecting them to some other network path. For example, an add-drop multiplexer may be used as a local “on-ramp” and “off-ramp” to a high-speed network.

In some embodiments, the first minimum loop width 412 of the optical waveguide loop 402 proximate the first coupling region 410 and the second minimum loop width 413 of the optical waveguide loop 402 proximate the second coupling region 411 may correspond to a width of the first coupling waveguide 414 and/or the second coupling waveguide 415. For example, and as shown in FIG. 4, the first minimum loop width 412 may correspond to and/or be fixed according to the width of the first coupling waveguide 414, and the first minimum loop width 412 may be a minimum width for the optical waveguide loop 402. Further, and as shown in FIG. 4, the second minimum loop width 413 may correspond to and/or be fixed according to the width of the second coupling waveguide 415, and the second minimum loop width 413 may be a minimum width for the optical waveguide loop 402.

In some embodiments, the optical ring resonator 400 may have an axis 416, a center point 428 (e.g., a point within the optical ring resonator 400 that is equidistant from the circular path 404), and a radial vector 420. For example, and as shown in FIG. 4, the axis 416 may pass through the first coupling region 410, the second coupling region 411, and the center point 428, thereby defining the alignment of the axis 416 with respect to the optical ring resonator 400. Further, in some embodiments, the radial vector 420 may start from the center point 428 and may extend to a position on the optical waveguide loop 402. In some embodiments, and as shown in FIG. 4, the offset of the radial vector 420 from the axis 416 may define an angle 418. The angle 418 may be used to identify a location along the circular path 404 of the optical waveguide loop 402. Further, in some embodiments, for a specific value of the angle 418 there may be a corresponding inner radius 406 and outer radius 408, where the value of the inner radius 406 and outer radius may be dependent on the value of the angle 418. In other words, the angle 418 may serve as a variable in a function defining a radius value for some embodiments of the optical ring resonator 400.

For example, and as shown in FIG. 4, the inner radius 406 may decrease along the circular path 404 from an initial point 430 in an initial loop width with an initial, maximum inner radius in the first coupling region 410 to a minimum inner radius at another point 432, corresponding to the position of the first maximum loop width 422. In some embodiments, the change of the inner radius 406 from a maximum to a minimum value may correspond with a rotation of the angle 418 by around 90 degrees along the circular path 404, as shown in FIG. 4. Additionally, or alternatively, the inner radius 406 may increase in value along the circular path 404 from the position of the first maximum loop width 422 for around another 90 degrees before reaching the second coupling region 411, as shown in FIG. 4.

In some embodiments, the inner radius 406 may decrease in value along the circular path 404 from the second coupling region 411 for around another 90 degrees before reaching a second maximum loop width 423, as shown in FIG. 4. As will be appreciated by one of ordinary skill in the art in view of the present disclosure, a first maximum loop width 422 and a second maximum loop width 423 may be of equal value to one another. Finally, in some embodiments, and as shown in FIG. 4, the inner radius 406 may increase in value along the circular path 404 from the position of the second maximum loop width 423 for around another 90 degrees before reaching the first minimum loop width 412 in the first coupling region 410.

Further, and as shown in FIG. 4, the outer radius 408 may increase along the circular path 404 from an initial point 430 in an initial loop width with an initial, minimum outer radius in the first coupling region 410 to a maximum outer radius at another point 432, corresponding to the position of the first maximum loop width 422. In some embodiments, the change of the outer radius 408 from a minimum to a maximum value may correspond with a rotation of the angle 418 by around 90 degrees along the circular path 404, as shown in FIG. 4. Additionally, or alternatively, the outer radius 408 may decrease in value along the circular path 404 from the position of the first maximum loop width 422 for around another 90 degrees before reaching a second coupling region 411, as shown in FIG. 4.

In some embodiments, the outer radius 408 may increase in value along the circular path 404 from the second coupling region 411 for around another 90 degrees before reaching a second maximum loop width 423, as shown in FIG. 4. Finally, in some embodiments, and as shown in FIG. 4, the outer radius 408 may decrease in value along the circular path 404 from the position of the second maximum loop width 423 for around another 90 degrees before reaching the first minimum loop width 412 in the first coupling region 410.

In some embodiments, and as shown in FIG. 4, the changing in value of the inner radius 406 and the outer radius 408 may correspond with a changing in value of the width W along the circular path 404 of the optical waveguide loop 402. In other words, the changes in radius values may cause a tapering up or tapering down in the width W of the optical waveguide loop 402. In some embodiments, the inner radius 406 and the outer radius 408 may not steadily increase or decrease in value from a minimum to maximum value or a maximum to minimum value. Stated differently, the inner radius 406 and the outer radius 408 may briefly decrease in value during an otherwise increasing period of radii value or may briefly increase in value during an otherwise decreasing period of radii value. In some embodiments, the optical waveguide loop 402 may have at least one axis of symmetry. For example, the optical waveguide loop 402 may have mirror symmetry across the axis 416, as shown in FIG. 4. As another example, the optical waveguide loop 402 may have mirror symmetry across another axis (not shown) passing through the position of the second maximum loop width 423, the center point 428, and the position of the first maximum loop width 422, as shown in FIG. 4.

In some embodiments, the inner radius 406 and outer radius 408 may be determined via functions (e.g., one or more Fourier series and/or the like). Additionally, or alternatively, the functions may be dependent on the angle 418. For example, the function determining the inner radius 406 and the outer radius 408 may have the form

$$r ( θ ) = {r}_{0} + {\sum }_{n = 1}^{N} ( {c}_{n} cos 2 n θ ) - {\sum }_{n = 1}^{N} ( {c}_{n} ) ,$$

where r(θ) may be the value for the inner radius 406 or the outer radius 408, r₀ may be an initial value for the inner radius 406 or the outer radius 408 (e.g., in the first coupling region 410 and/or the second coupling region 411), and cₙ's may be coefficients associated with a Fourier series. As will be appreciated by one of ordinary skill in the art in view of the present disclosure, the values of the coefficients cₙ may be set to optimize or minimize certain aspects of a system. In some embodiments, the functions may include different terms, may truncate at different orders of N, may have different and/or additional variable dependencies, and/or the like.

In some embodiments, the optical ring resonator 400 may include a substrate 426, and the first coupling waveguide 414, the second coupling waveguide 415, and the optical waveguide loop 402 may be etched on the substrate 426. For example, the optical ring resonator 400 may be manufactured in a manner similar to the method 800 as shown and described herein with respect to FIG. 8.

As will be appreciated by one of ordinary skill in the art in view of the present disclosure, the optical ring resonator 400 may include other elements, such as additional coupling waveguides, additional optical waveguide loops, heating elements, and/or the like. For example, the optical ring resonator 300 may include a metal heater, a silicon heater, a PN junction, and/or the like for tuning the optical ring resonator. In some embodiments, a metal heater and/or a silicon heater may tune the resonance wavelength in a relatively slow manner, while a PN junction may tune the resonance wavelength in a relatively fast manner. As another example, embodiments may correspond to a couple-resonator optical waveguide (CROW), which may include multiple stacked optical waveguide loops. Additionally, or alternatively, embodiments of the optical ring resonator 400 may not include coatings (e.g., due to incompatibility with CMOS technology).

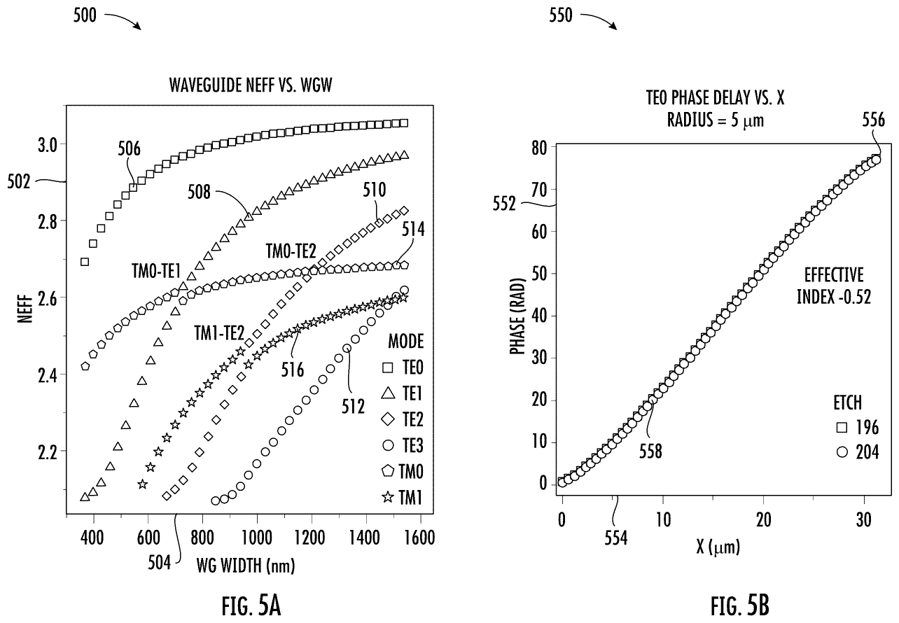

FIG. 5A illustrates a graph 500 of effective refractive indices of optical waveguide loops versus widths of the optical waveguide loops for a plurality of light modes, for an optical ring resonator in accordance with an embodiment of the present disclosure. In some embodiments, the optical ring resonator may be similar to the optical ring resonator 300 and/or the optical ring resonator 400 as shown and described herein with respect to FIGS. 3 and 4, respectively. The graph 500 includes a y-axis 502 and an x-axis 504, where the y-axis 502 lists values of effective refractive indices for the optical waveguide loops and the x-axis 504 lists values of the width of the optical waveguide loop in nanometers. The graph 500 further includes a plurality of data points per mode of light defining the fits 506, 508, 510, 512, 514, and 516 for an optical ring resonator in accordance with an embodiment of the present disclosure.

As will be appreciated by one of ordinary skill in the art in view of the present disclosure, the graph 500 demonstrates that as the width of the optical waveguide loop increases, an optical ring resonator may be capable of supporting the propagation of higher order modes of light. In other words, optical ring resonators in accordance with some embodiments of the present disclosure may be configured to support a set of higher order modes of light based on a selected width of the optical waveguide loop.

FIG. 5B illustrates a graph 550 of phase delay of a fundamental mode of light versus positions of light along a circular path for two etch depth values of an optical waveguide loop, for a ring resonator in accordance with an embodiment of the present disclosure. In some embodiments, the optical ring resonator may be similar to the optical ring resonator 300 and/or the optical ring resonator 400 as shown and described herein with respect to FIGS. 3 and 4, respectively. The graph 550 includes a y-axis 552 and an x-axis 554, where the y-axis 552 lists values of phase delay of the fundamental mode of light in radians for the optical waveguide loop and the x-axis 554 lists values of the position of light along a circular path of the optical waveguide loop in micrometers (e.g., a circular path similar to the circular path 304 and/or the circular path 404 as shown and described herein with respect to FIGS. 3 and 4, respectively).

The graph 550 further includes a plurality of data points per etch depth value defining the fits 556 and 558 for optical ring resonators, in accordance with embodiments of the present disclosure. In particular, the fit 556 corresponds to data points for an optical ring resonator in accordance with an embodiment of the present disclosure having an optical-waveguide-loop etch depth of 0.196 microns. The fit 558 corresponds to data points for an optical ring resonator in accordance with an embodiment of the present disclosure having an optical-waveguide-loop etch depth of 0.204 microns.

As will be appreciated by one of ordinary skill in the art in view of the present disclosure, the graph 550 demonstrates that the further the fundamental mode of light propagates along the circular path of the optical waveguide loop, the more the phase of the fundamental mode of light shifts. However, the dependence on the etch depth of the optical waveguide loop of the optical ring resonator is minimized, as shown by the close proximity of the fits 556 and 558 in the graph 550 of FIG. 5.

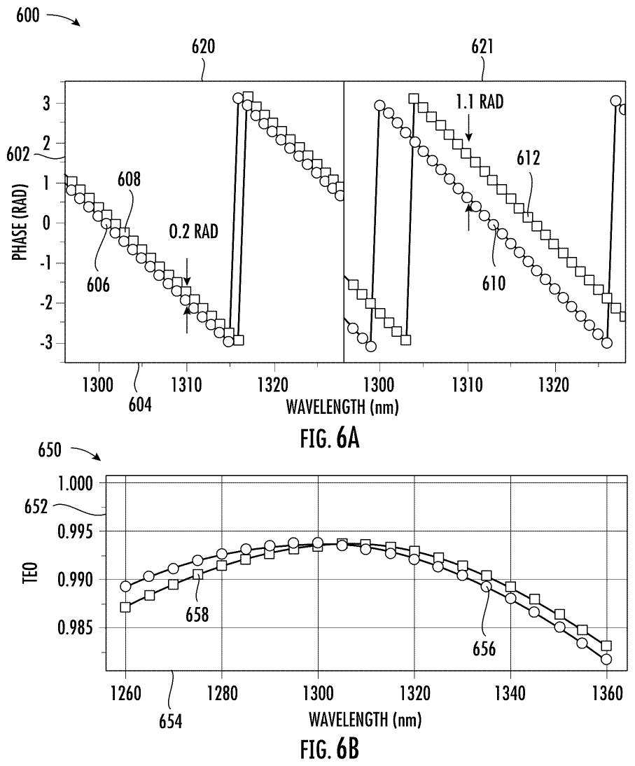

FIG. 6A illustrates a graph 600 of phases of propagating light versus wavelengths of light at two different etch depth values for two optical ring resonators in accordance with embodiments of the present disclosure 620 and for two conventional optical ring resonators 621 (e.g., with circular geometries). In some embodiments, the two optical ring resonators in accordance with embodiments of the present disclosure 620 may be similar to the optical ring resonator 300 and/or the optical ring resonator 400 as shown and described herein with respect to FIGS. 3 and 4, respectively. The graph 600 includes a y-axis 602 and an x-axis 604, where the y-axis 602 lists values of the phase of the propagating light in radians and the x-axis 604 lists values of the wavelengths of light in nanometers.

The graph 600 further includes a plurality of data points per etch depth value for the two optical ring resonators in accordance with embodiments of the present disclosure 620 defining fits 606 and 608 and another plurality of data points per etch depth value for the two conventional optical ring resonators 621 defining the fits 610 and 612. In particular, fit 606 corresponds to data points for an optical ring resonator in accordance with an embodiment of the present disclosure having an optical-waveguide-loop etch depth of 0.196 microns, and fit 608 corresponds to data points for a similar optical ring resonator in accordance with an embodiment of the present disclosure but having an optical-waveguide-loop etch depth of 0.204 microns. Fit 610 corresponds to a conventional optical ring resonator having an optical-waveguide-loop etch depth of 0.204 microns, and fit 612 corresponds to a conventional optical ring resonator having an optical-waveguide-loop etch depth of 0.196 microns.

As will be appreciated by one of ordinary skill in the art in view of the present disclosure, the graph 600 demonstrates that for conventional optical ring resonators there is a large variation (e.g., the variation between fits 610 and 612 being 1.1 radians) in the phase of the propagating light when there is a variation (e.g., 8 nanometers) in the etch depth value of the optical waveguide loop. Further, as compared to conventional optical ring resonators, the variation in the phase of the propagating light is reduced (e.g., the variation between fits 606 and 608 being 0.2 radians) for optical ring resonators in accordance with embodiments of the present disclosure for the same variation in the etch depth (e.g., 8 nanometers). Thus, in some embodiments, optical ring resonators in accordance with the present disclosure may have a geometry configured to achieve a phase variation due to changes in etch depth that is half, one third, one fourth, or even one fifth of the phase variation due to changes in etch depth occurring in corresponding conventional ring resonators (e.g., with a circular geometry).

FIG. 6B illustrates a graph 650 of values for the proportion of the fundamental mode of light propagated through half of the circular path of an optical waveguide loop (e.g., similar to the circular path 404 of the optical waveguide loop 402 shown and described herein with respect to FIG. 4) versus wavelengths of light at two different etch depth values for optical ring resonators in accordance with embodiments of the present disclosure. In some embodiments, the optical ring resonators may be similar to the optical ring resonator 300 and/or the optical ring resonator 400 as shown and described herein with respect to FIGS. 3 and 4, respectively. The graph 650 includes a y-axis 652 and an x-axis 654, where the y-axis 652 lists values of the proportion of the fundamental mode of light propagated and the x-axis 654 lists values of the wavelengths of light in nanometers.

The graph 650 further includes a plurality of data points per etch depth value for an optical ring resonator in accordance with an embodiment of the present disclosure defining the fits 656 and 658. In particular, the fit 656 corresponds to data points for an optical ring resonator in accordance with an embodiment of the present disclosure having an optical-waveguide-loop etch depth of 0.204 microns, and fit 658 corresponds to data points for a similar optical ring resonator in accordance with an embodiment of the present disclosure but having an optical-waveguide-loop etch depth of 0.196 microns.

As will be appreciated by one of ordinary skill in the art in view of the present disclosure, the propagation of higher order modes of light may be unwanted in many optical systems as higher order modes of light may degrade the performance of the optical system (e.g., parasitic higher order mode resonance). Optical ring resonators in accordance with some embodiments of the present disclosure may be configured to support the propagation of higher order modes of light to couple to the fundamental mode of light. Such coupling may reduce the sensitivity of the optical ring resonators to variations in etch depth of the optical waveguide loops. Further, the proportion of the higher order modes of light transmitted from the optical waveguide loops may be minimized to improve overall performance on optical systems incorporating such optical ring resonators.

As will be appreciated by one of ordinary skill in the art in view of the present disclosure, the graph 650 demonstrates that the optical ring resonators in accordance with embodiments of the present disclosure may achieve such coupling of higher order modes to the fundamental mode to reduce etch-depth sensitivity. The fits 656 and 658 demonstrate almost no variation from optical ring resonators having different etch-depth values (e.g., 8 nanometer difference) of the optical waveguide loops. Further, the graph 650 demonstrates, via the fits 656 and 658, that a high proportion (e.g., ˜99.3%) of the fundamental mode of the light is propagated through half of the circular path of the optical waveguide loop.

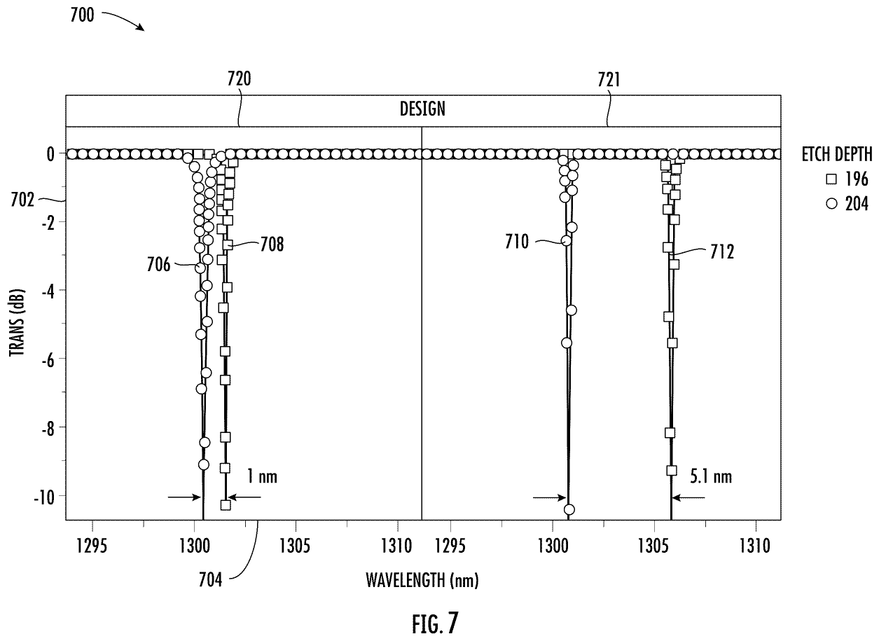

FIG. 7 illustrates a graph 700 of transmissions of light from optical waveguide loops at different wavelength values of light for two optical ring resonators in accordance with embodiments of the present disclosure 720 having different etch depth values and for two conventional optical ring resonators 721 (e.g., with circular geometries) having different etch depth values. In some embodiments, the two optical ring resonators in accordance with embodiments of the present disclosure 720 may be similar to the optical ring resonator 300 and/or the optical ring resonator 400 as shown and described herein with respect to FIGS. 3 and 4, respectively. The graph 700 includes a y-axis 702 and an x-axis 704, where the y-axis 702 lists values of light transmitted from optical waveguide loops in decibels (e.g., the proportion of the transmitted light that is the fundamental mode including both the coupling waveguides and the entirety of the optical waveguide loops) and the x-axis 704 lists values of the wavelengths of the light in nanometers.

The graph 700 further includes a plurality of data points per etch depth value for the two optical ring resonators in accordance with embodiments of the present disclosure 720 defining fits 706 and 708 and another plurality of data points per etch depth value for the two conventional optical ring resonators 721 defining the fits 710 and 712. In particular, fit 706 corresponds to data points for an optical ring resonator in accordance with an embodiment of the present disclosure having an optical-waveguide-loop etch depth of 0.204 microns, and fit 708 corresponds to data points for a similar optical ring resonator in accordance with an embodiment of the present disclosure but having an optical-waveguide-loop etch depth of 0.196 microns. Fit 710 corresponds to a conventional optical ring resonator having an optical-waveguide-loop etch depth of 0.204 microns, and fit 712 corresponds to a conventional optical ring resonator having an optical-waveguide-loop etch depth of 0.196 microns.

As will be appreciated by one of ordinary skill in the art in view of this disclosure, the graph 700 demonstrates that the wavelength of light transmitted by a given optical ring resonator is concentrated around a particular wavelength of light that depends on both (i) the etch depth and (ii) the geometry of the optical ring resonator. The particular wavelength for each of the optical ring resonators is shown via the peaks of fits 706, 708, 710, and 712. Such a particular wavelength of light may be referred to as a resonant wavelength of a given optical ring resonator.

As shown in FIG. 7, a difference in etch depth causes a shift in resonant wavelength of the optical ring resonators. However, the shift in the resonant wavelength of the optical ring resonators in accordance with embodiments of the present disclosure is half, one third, one fourth, or even one fifth of the shift in resonant wavelength of the conventional optical ring resonators. As shown in FIG. 7 by comparing the peaks of fits 706 and 708, the geometries of the optical ring resonators in accordance with embodiments of the present disclosure may be configured to minimize the shift in the resonant wavelength due to an 8-nanometer difference in etch depth to about 1 nanometer. As also shown in FIG. 7 by comparing the peaks of fits 710 and 712, the conventional optical ring resonators (e.g., with circular geometries) experience a shift in the resonant wavelength due to an 8-nanometer difference in etch depth of about 5.1 nanometers. Thus, FIG. 7 demonstrates that geometries of optical ring resonators in accordance with embodiments of the present disclosure may reduce resonance-wavelength sensitivity of the optical ring resonators to variations in etch depth as compared to conventional optical ring resonators (e.g., with circular geometries).

FIG. 8 illustrates a method 800 for manufacturing an optical device, in accordance with an embodiment of the present disclosure. In some embodiments, the method 800 may be used to manufacture optical ring resonators with an advanced geometry (e.g., similar to the optical ring resonator 300 shown and described herein with respect to FIG. 3 and/or the optical ring resonator 400 shown and described herein with respect to FIG. 4).

As shown in block 802, the method 800 may include providing a substrate including at least one bus waveguide. For example, the substrate may include silicon-on-insulator, polymer, plasmonic material, and/or the like. In some embodiments, the method 800 may include etching the at least one bus waveguide in the substrate. Additionally, or alternatively, the substrate may include two bus waveguides extending across the substrate parallel to each other.

As shown in block 804, the method 800 may include etching, in the substrate, an optical waveguide loop, where the optical waveguide loop defines a path, where the optical waveguide loop has an inner radius and an outer radius, and where at least one of the inner radius or the outer radius is variable along the path of the optical waveguide loop. In some embodiments, the method 800 may include etching the optical waveguide loop to have a geometry similar to the optical ring resonator 300 shown and described herein with respect to FIG. 3 and/or the optical ring resonator 400 shown and described herein with respect to FIG. 4. Additionally, or alternatively, the inner radius may have an inner radius length, the outer radius may have an outer radius length, and the inner radius length and the outer radius length may be determined by a Fourier series. For example, the method 800 may include determining the Fourier series that determines the inner radius length and the outer radius length and/or determining one or more coefficients, initial radius values, and/or the like of the Fourier series.

In some embodiments, etching the optical waveguide loop in the substrate may include etching the optical waveguide loop in the substrate using photolithography techniques and dry-etching techniques. Additionally, or alternatively, the method 800 may be CMOS-compatible.

As will be appreciated by one of ordinary skill in the art in view of this disclosure, the present disclosure may include and/or be embodied as an apparatus (including, for example, a photodetector, a device, and/or the like), as a method (including, for example, a manufacturing method, a computer-implemented process, and/or the like), or as any combination of the foregoing.

Although many embodiments of the present disclosure have just been described above, the present disclosure may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present disclosure described and/or contemplated herein may be included in any of the other embodiments of the present disclosure described and/or contemplated herein, and/or vice versa.

While certain exemplary embodiments have been described and shown in the accompanying drawings, it is to be understood that such embodiments are merely illustrative of and not restrictive on the broad disclosure and that this disclosure is not to be limited to the specific constructions and arrangements shown and described, as various other changes, combinations, omissions, modifications and substitutions, in addition to those set forth in the above paragraphs, are possible. In light of this disclosure, those skilled in the art will appreciate that various adaptations, modifications, and combinations of the just described embodiments may be configured without departing from the scope and spirit of the disclosure. Therefore, it is to be understood that, within the scope of the appended claims, the disclosure may be practiced other than as specifically described herein.

1. An optical device, comprising:
a substrate; and
an optical waveguide loop formed on the substrate, wherein the optical waveguide loop defines a path, wherein the optical waveguide loop has an inner radius, and wherein the inner radius has a length that is variable along the path of the optical waveguide loop.

2. The optical device of claim 1, wherein the optical waveguide loop has an outer radius, and wherein the outer radius has a length that is variable along the path of the optical waveguide loop.

3. The optical device of claim 1, wherein a distance between the inner radius and a corresponding outer radius defines a width of the optical waveguide loop, and wherein the width is variable along the path of the optical waveguide loop.

4. The optical device of claim 3, wherein the width is varied to admit a plurality of higher order modes.

5. The optical device of claim 1, wherein the optical waveguide loop has at least one coupling region, and wherein a width of the optical waveguide loop has a minimum width at the at least one coupling region.

6. The optical device of claim 5, wherein the minimum width of the optical waveguide loop corresponds to a width of a coupling light transmitting element.

7. The optical device of claim 5, wherein:
the optical waveguide loop has a center point substantially equidistant from the path;
the at least one coupling region and the center point define an axis of the optical waveguide loop;
a radial vector extending from the center point to the path defines an angle θ; and
the length of the inner radius varies along the path as a function of the angle θ.

8. The optical device of claim 7, wherein the optical waveguide loop has an outer radius, wherein the outer radius has a length that varies along the path as a function of the angle θ, wherein the optical waveguide loop is configured to act as an all-pass filter, and wherein the inner radius and the outer radius are defined by the function:
$$r ( θ ) = {r}_{0} + {\sum }_{n = 1}^{N} ( {c}_{n} cos n θ ) - {\sum }_{n = 1}^{N} ( {c}_{n} ) .$$

9. The optical device of claim 7, wherein the optical waveguide loop has an outer radius, wherein the outer radius has a length that varies along the path as a function of the angle θ, wherein the optical waveguide loop is configured to act as an add-drop multiplexer, and wherein the inner radius and the outer radius are defined by the function:
$$r ( θ ) = {r}_{0} + {\sum }_{n = 1}^{N} ( {c}_{n} cos 2 n θ ) - {\sum }_{n = 1}^{N} ( {c}_{n} ) .$$

10. The optical device of claim 7, wherein the function is a Fourier series.

11. The optical device of claim 7, wherein the function is a series expansion of a function.

12. The optical device of claim 1, wherein the optical waveguide loop has at least one axis of symmetry.

13. The optical device of claim 1, wherein the optical waveguide loop is configured to couple a fundamental mode to a plurality of higher order modes propagating within the optical waveguide loop.

14. The optical device of claim 13, wherein coupling of the fundamental mode to the plurality of higher order modes reduces sensitivity of the optical device to variations in etch depth of the optical waveguide loop.

15. A method of manufacturing an optical device, the method comprising:
providing a substrate comprising at least one bus waveguide; and
etching, in the substrate, an optical waveguide loop, wherein the optical waveguide loop defines a path, wherein the optical waveguide loop has an inner radius and an outer radius, and wherein at least one of the inner radius or the outer radius is variable along the path of the optical waveguide loop.

16. The method of claim 15, wherein the substrate comprises at least one of a silicon-on-insulator, polymer, or plasmonic material.

17. The method of claim 15, wherein the inner radius has an inner radius length, wherein the outer radius has an outer radius length, and wherein the inner radius length and the outer radius length are determined by a Fourier series.

18. The method of claim 15, wherein etching the optical waveguide loop in the substrate comprises etching the optical waveguide loop in the substrate using photolithography techniques and dry-etching techniques.

19. The method of claim 15, wherein the method of manufacturing is CMOS-compatible.

20. An optical ring resonator, comprising:
a substrate; and
an optical waveguide loop formed on the substrate,
wherein the optical waveguide loop defines a circular path,
wherein the optical waveguide loop has an inner radius and an outer radius,
wherein a distance between the inner radius and the outer radius at a given point along the circular path defines a loop width, and
wherein the loop width is variable along the circular path.

21. The optical ring resonator of claim 20, wherein at an initial point along the circular path the inner radius has an initial inner radius and the outer radius has an initial outer radius, and wherein a distance between the initial inner radius and the initial outer radius at the initial point defines an initial loop width.

22. The optical ring resonator of claim 21, wherein the initial loop width is a minimum loop width, and wherein, at another point along the circular path rotated at around 90 degrees from the initial point, the loop width is a maximum loop width.

23. The optical ring resonator of claim 21, wherein the initial loop width is a minimum loop width, and wherein, at another point along the circular path rotated at around 180 degrees from the initial point, the loop width is a maximum loop width.
